(19) United States
(12) Patent Application Publication
(10) Pub. No.: US 2020/0380626 A1
(43) Pub. Date: Dec. 3, 2020

(54) VALIDATING IDENTIFICATION DOCUMENTS BASED ON CASE-BASED BEHAVIORS

(71) Applicant: Capital One Services, LLC, McLean, VA (US)

(72) Inventors: Nicholas Capurso, McLean, VA (US); Jason PRIBBLE, McLean, VA (US); Daniel Alan JARVIS, McLean, VA (US)

(73) Assignee: Capital One Services, LLC, McLean, VA (US)

(21) Appl. No.: 16/426,719

(22) Filed: May 30, 2019

(51) Int. Cl. G06Q 50/26; H04L 29/06; G06Q 20/32; G06Q 20/34

(52) U.S. Cl. CPC G06Q 50/265; H04L 63/08; G06Q 20/20; G06Q 20/354; G06Q 20/3224

(57) ABSTRACT

The present disclosure is directed to systems and methods for validating identification documents based on case-based behaviors. The method may include: receiving, at a computing device, a request to access account information of a user from a user device; analyzing, using the computing device, an environmental context of the user device; determining, using the computing device, a priority level for validating an identification document of the user based on the environmental context; dynamically setting, using the computing device, a validation process for validating the identification document based on the priority level; and in response to the identification document being validated, providing, using the computing device, the user device with access to the account information.

### BACKGROUND

Some entities, such as financial institutions, banks, and the like, permit users to capture an image of a identification document (e.g., government-issued identification (ID) cards and the like) using a user device, and submit the images to a backend-platform for validating the identification document. For example, the backend-platform may analyze the identification document to determine if the identification document is valid, extract text from the identification document, or the like. However, some backend-platforms may reject an uploaded image for not meeting image quality standards. In some instances, the uploaded image may include additional image data, such as image data related to a supporting surface for the identification documentation (e.g., a table, countertop, desktop, and the like), and the backend platform may reject the uploaded image because the additional image data does not meet the image quality standards, even though the additional image data is irrelevant to the image quality of the identification documentation in the uploaded images. Additionally, the backend-platform may erroneously reject the uploaded image because it is not familiar with the format or template of the identification document. This may result in genuine users failing the validation, which leads to a loss in opportunity if the user's situation should have been given higher priority for validating the identification document.

### BRIEF SUMMARY OF THE INVENTION

According to some aspects, the present disclosure is directed to a method that may include: receiving, at a computing device, a request to access account information of a user from a user device; analyzing, using the computing device, an environmental context of the user device; determining, using the computing device, a priority level for validating an identification document of the user based on the environmental context; dynamically setting, using the computing device, a validation process for validating the identification document based on the priority level; and in response to the identification document being validated, providing, using the computing device, the user device with access to the account information.

According to further aspects, the present disclosure is directed to a system that may include a memory for storing instructions for dynamically setting a validation process for validating an identification document of a user and a processor, communicatively coupled to the memory, configured to execute the instructions. The instructions may direct the processor to: receive a request to access account information of the user from a user device; analyze an environmental context of the user device; determine a priority level for validating the identification document based on the environmental context; dynamically set the validation process for validating the identification document based on the priority level; and in response to the identification document being validated, provide the user device with access to the account information.

According to further aspects, the present disclosure is directed to a non-transitory, tangible computer-readable device having instructions stored thereon that, when executed by at least one computing device, causes the at least one computing device to perform operations that may include: receiving, at a computing device, a request to access account information of a user from a user device; analyzing, using the computing device, an environmental context of the user device; determining, using the computing device, a priority level for validating an identification document of the user based on the environmental context; dynamically setting, using the computing device, a validation process for validating the identification document based on the priority level; and in response to the identification document being validated, providing, using the computing device, the user device with access to the account information.

### BRIEF DESCRIPTION OF THE DRAWINGS/FIGURES

The accompanying drawings are incorporated herein and form a part of the specification.

FIG. 1 is a block diagram of a database system that includes a cache implemented using non-RAM memory, according to some embodiments.

FIG. 2 is a flowchart illustrating a process for validating identification documents based on case-based behaviors, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof, for validating identification documents based on case-based behaviors. By dynamically setting the process for validating identification documents based on case-based behaviors, embodiments of the present disclosure improve existing computer technology by preventing against false negatives of valid identification documents, expediting processing of identification documents, and preventing against fraudulent purchases, therefore improving the functionality of computing systems.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

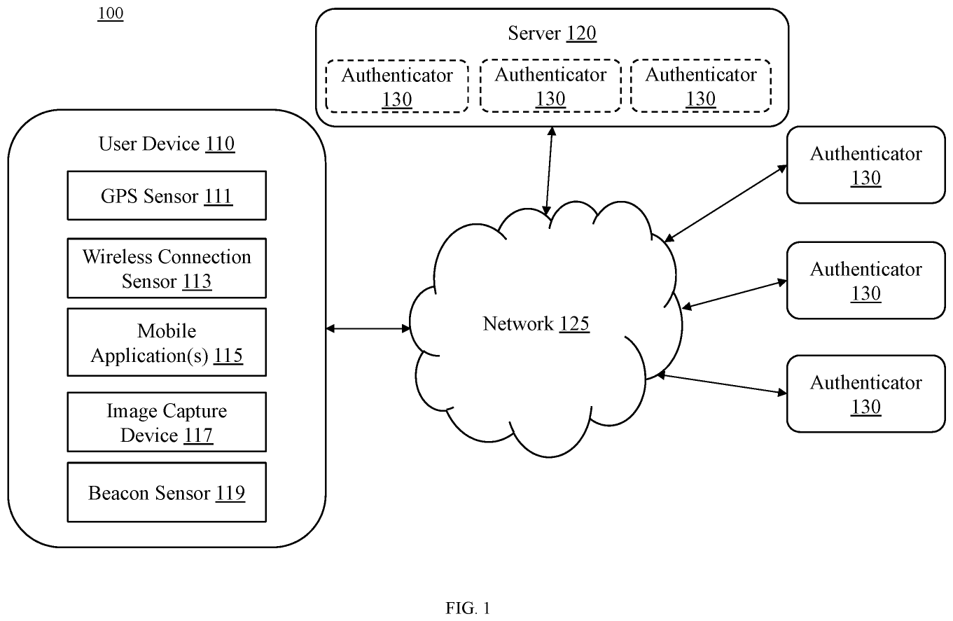

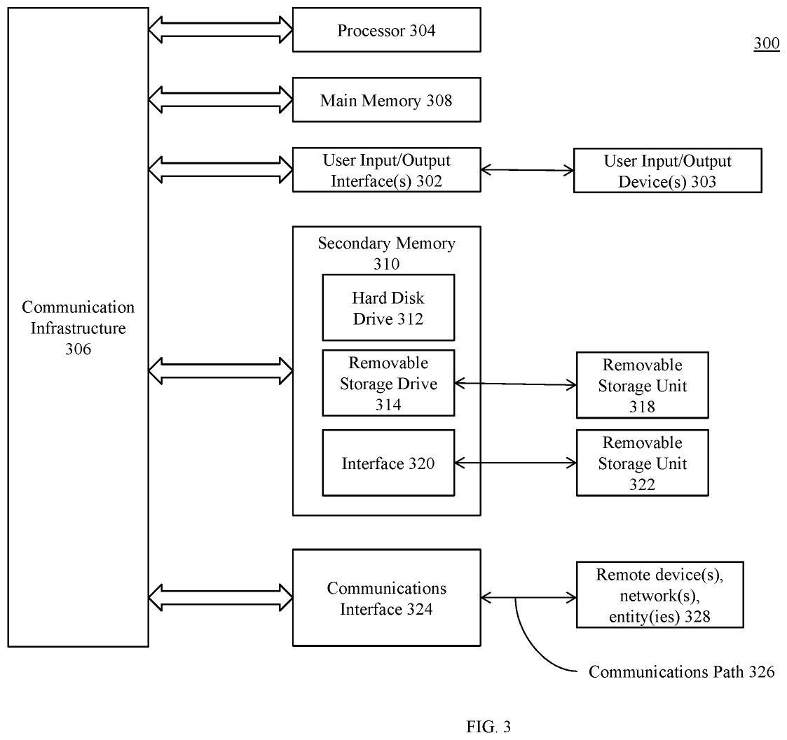

FIG. 1 is a diagram of an example environment 100 in which systems and/or methods, described herein, may be implemented. As shown in FIG. 1, environment 100 may include a user device 110, a server 120, a network 125, and a plurality of authenticators 130. Devices of the environment 100 may interconnect via wired connections, wireless connections, or a combination of wired and wireless connections. Devices of environment 100 may include a computer system 300 shown in FIG. 3, discussed in greater detail below.

The user device 110 may include a device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. In some embodiments, the user device 110 may include a global position system (GPS) sensor 111 used for tracking a location of the user device 110, a wireless connection sensor 112 for tracking a wireless connection of the user device 110 (e.g., a public network, an office network, or a home network), and/or a beacon sensor 119 for tracking a proximity of the user device 110 to a point-of-sale system (e.g., using a near-field communication (NFC) signal, a Bluetooth signal, or the like). The user device 110 may also include an image capture device 117, such as a camera, for capturing an image of, for example, an identification document. In some embodiments, the image capture device 117 may support one or more image resolutions. In some embodiments, an image resolution may be represented as a number of pixel columns (width) and a number of pixel rows (height), such as 1280×720, 1920×1080, 2592×1458, 3840×2160, 4128×2322, 5248×2952, 5312×2988, or the like, where higher numbers of pixel columns and higher numbers of pixel rows are associated with higher image resolutions. In some embodiments, the image capture device 117 may support a first image resolution that is associated with a quick capture mode, such as a low image resolution for capturing and displaying low-detail preview images on a display of the user device. In some embodiments, the image capture device 117 may support a second image resolution that is associated with a full capture mode, such as a high image resolution for capturing a high-detail image. In some embodiments, the full capture mode may be associated with the highest image resolution supported by the image capture device 117. In some embodiments, the user device 110 may send the captured image, via the network 125, to the server 120 for processing and/or validating the captured image. In some embodiments, the user device 110 may receive a message or any other type of information from the server 120, which may be displayed on the user device 110.

In some embodiments, the user device 110 may also include one or more mobile applications 115. For example, the one or more mobile applications 115 may include a mobile application associated with an operator of the server 120, an application used to purchase goods from any number of manufacturers and/or distributors, a universal payment application that may be used at any retailer or the like, a retailer specific application that is used to purchase goods and/or services from such retailer, etc. In some embodiments, the user may send a request to the server 120 to access information associated with an account managed by the operator of the server 120. As a part of the request, the user may be prompted to capture an image of an identification document (e.g., a driver's license, passport, etc.) and transmit the image to the server device in order to validate an identify of the user. For example, the user may be prompted to capture an image of the identification document while the identification document is set flat against a background in a well-lit space and to make sure the entire identification document is in focus, which may then be transmitted to the server 120 for processing the identification document and providing access to the account information in response to the identification document being validated.

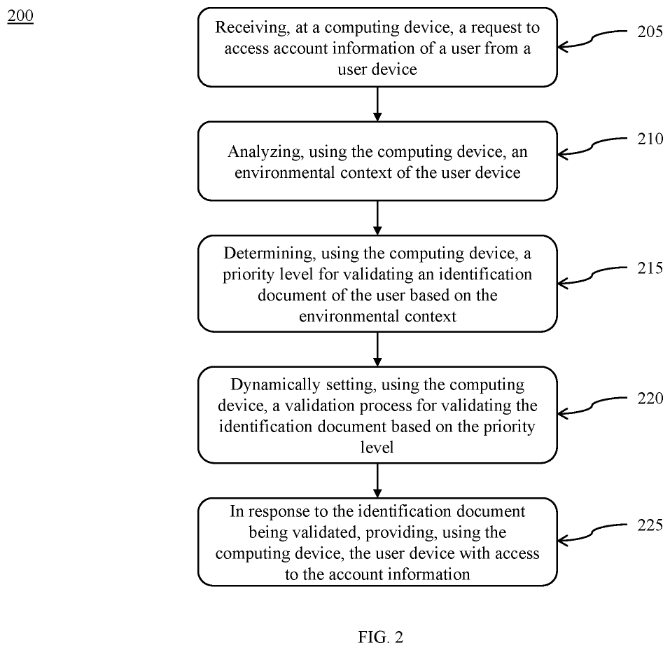

The server 120 may include a server device (e.g., a host server, a web server, an application server, etc.), a data center device, or a similar device, capable of communicating with the user device 110 via the network 125. In some embodiments, the server 120 may determine the processes for validating the identification document, as discussed with respect to FIG. 2.

The network 125 may include one or more wired and/or wireless networks. For example, the network 125 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The plurality of authenticators 130 may include a server device (e.g., a host server, a web server, an application server, etc.), a data center device, or a similar device, capable of communicating with the server 120 via the network 125. In some embodiments, the server 120 may transmit the image of the identification document to one or more of the authenticators 130, and in response to receiving the image of the identification document, the one or more of the authenticators 130 may analyze the image to authenticate the identification document. That is, in some embodiments, the plurality of authenticators 130 may analyze the image of the authentication document to determine whether the identification document is authentic. However, each authenticator of the plurality of authenticators may analyze the identification document based on different templates. Furthermore, in some embodiments, one or more of the plurality of authenticators may provide additional features for analyzing the image of the authentication document. For example, some features may include, but are not limited to, matching a self-portrait type image of the user or any other non-government issued image of the user against the image of the user on the identification document. Thus, by transmitting the image of the identification document to one or more of the authenticators 130, the present disclosure advantageously provides for a more robust range of templates and features that may be used to analyze the identification document. In some embodiments, the plurality of authenticators may be integrated within the server 120.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

FIG. 2 is a flow chart of an example method 200 for validating identification documents based on case-based behaviors. In some embodiments, one or more processes described with respect to FIG. 2 may be performed by a server device (e.g., the server 120 of FIG. 1). In some embodiments, the method 200 may include receiving a request to access account information of a user from a user device (e.g., the user device 110 of FIG. 1) at block 205. The request to access the account information may also include an image of an identification document used to validate an identity of the user. In response to receiving the request to access the account information, the method 200 may also include analyzing an environmental context of the user device at block 210. In some embodiments, analyzing the environmental context may include determining whether the user device 110 is near a point-of-sale system based on a global positioning system (GPS) location (e.g., based on information from the GPS sensor 111 of the user device 110), a wireless connection (e.g., based on information from the wireless connection sensor 113 of the user device 110), or a beacon signal (e.g., information from the beacon sensor 119 of the user device 110). In further embodiments, analyzing the environmental context may include determining whether the user is attempting to conduct an on-line purchase at a public location or a home location based on the GPS location (e.g., based on information from the GPS sensor 111) or the wireless connection (e.g., based on information from the wireless connection sensor 113). That is, using information obtained from the GPS sensor 111 or wireless connection sensor 113, the server 120 may determine whether the user device 110 is at the public location, such as a retail location, when the GPS location is a known retail location or the wireless connection is a public wireless network. Alternatively, the server 120 may determine that the user device 110 is located at the home location if the GPS location matches a known home location of the user and/or connected to a wireless network identified as being a home network by the user.

In further embodiments, analyzing the environmental context may include determining whether the user is attempting to conduct a purchase while traveling based on travel predictions. For example, the server 120 may determine whether the user device 110 is located at a location known for traveling, such as, but not limited to, an airport, a train station, a bus station, or the like, and the server 120 may then determine whether the user device 110 is located at a second location known for traveling, such as a different airport, train station, bus station, or the like. That is, by tracking the user device 110 from different locations known for traveling, the server 120 may determine that the user is traveling, such that any purchases near the second location known for traveling may be considered as attempts to conduct a purchase while traveling. In another embodiment, credit card information can be accessed to determine whether a ticket was purchased to travel to from a certain location. In yet further embodiments, analyzing the environmental context may include determining whether the user is attempting to conduct a purchase at a location where a previous purchase was conducted using the GPS location (e.g., based on information from the GPS sensor 111) or the wireless connection (e.g., based on information from the wireless connection sensor 113). For example, the server 120 may track whether the user device 110 has been previously used at a given location based on whether the user device 110 has been previously used at that location based on the GPS location or the wireless connection, such that the server 120 may identify the location as being a location commonly frequented by the user.

In still further embodiments, analyzing the environmental context may include determining whether the user is attempting to conduct a purchase using a mobile application (e.g., the one or more mobile applications 115) operating on the user device 110. For example, the server 120 may receive information indicating that the one or more mobile applications 115, such as a mobile application used to purchase goods and/or services, is being operated on the user device 110, and using this information, the server 120 may determine that the user device 110 is being used to conduct a purchase via the one or more mobile applications 115. In other embodiments, analyzing the environmental context may include determining whether the user is updating a payment form for the one or more mobile applications 115 operating on the user device 110. For example, the one or more mobile applications 115 may include a universal payment application that may be used at any retailer or the like. Alternatively, or additionally, the one or more mobile applications 115 may include a retailer specific application, such that the payment form may be used to reload funds for making purchases at such retailer.

In still further embodiments, analyzing the environmental context may include determining whether the user is activating a credit card. For example, the one or more mobile applications 115 may include a mobile application associated with an operator of the server 120, which may issue the credit card to the user, and the mobile application 115 associated with the operator of the server 120 may be used to activate the credit card. In some embodiments, analyzing the environmental context may include determining whether the user is attempting to access the account information without attempting to conduct a transaction. For example, the user may use the user device 110 to access the account information for non-retail purposes, such as, but not limited, verifying an account number, without being associated with conducting a transaction.

In some embodiments, the method 200 may also include determining a priority level for validating an identification document of the user based on the environmental context at block 215. For example, in some embodiments, determining the priority level may include setting the priority level to a high priority level when the user device 110 is near the point-of-sale system, the user is attempting to conduct the on-line purchase at the public location, the user is attempting to conduct the purchase while traveling, the user is attempting to conduct the purchase at the location where the previous purchase was conducted, the user is attempting to conduct the purchase using the mobile application 115 operating on the user device, the user is updating the payment, or the user is activating the credit card. Alternatively, determining the priority level may include setting the priority level to a low priority level when the user is attempting to access the account information without attempting to conduct the transaction or the user is attempting to conduct the on-line purchase at the home location.

In some embodiments, the method 200 may also include dynamically setting, using the server 120, a validation process for validating the identification document based on the priority level at block 220. For example, when the priority level is set to the high priority level, dynamically setting the validation process may include transmitting the identification document to a plurality of authenticators (e.g., authenticators 130 of FIG. 1). In some embodiments, a first authenticator of the plurality of authenticators comprises a primary authenticator that first attempts to validate the identification document and remaining authenticators of the plurality of authenticators comprise secondary authenticators that attempt to validate the identification document when the first authenticator fails to validate the identification document. By transmitting the identification document to the plurality of authenticators 130, the server 120 may provide additional resources for validating the identification document that would have otherwise resulted in a potentially false negative. For example, the identification document may be formatted in a manner that is not recognized by one of the plurality authenticators (e.g., the identification format is not within the authenticator's database), but it may be a format recognized by another one of the plurality of authenticators. Alternatively, each of the plurality of authenticators may simultaneously attempt to validate the identification document. In some embodiments, whichever authenticator 130 validates the identification document first may respond to the server 120, thereby providing for expedited processing of the identification document. In further embodiments, the server 120 may receive validation of the identification document from two or more authenticators from among the plurality of authenticators, thereby providing for protection against fraudulent purchases.

In some embodiments, dynamically setting the validation process may include determining how to route the image of the identification document to the plurality of authenticators 130. For example, the server 120 may rank the plurality of authenticators 130 based on which authenticators provide the fastest results, most accurate results, least costly results, most likely to be able to return a result based on image quality, etc. Furthermore, the plurality of authenticators 130 may be ranked based on document validation results for a specific document type (e.g., a driver license), specific image information (e.g., a glare profile, a color profile), specific locations where an image was taken (e.g., certain GPS coordinates, i.e., home versus retail locations), or device type (e.g., mobile devices, tablets), device manufacturer, customer or user information, and/or operating system information. Using the ranked authenticators 130 and the priority level, the server 120 may determine which authenticator(s) 130 to send the image of the authentication document. For example, in some embodiments, for a low priority, the server 120 may transmit the image of the authentication document to an authenticator 130 that may be lower ranked based on being less expensive, providing slower results, and/or providing lower validation results. In contrast, in some embodiments, for a high priority, the server 120 may transmit the image of the authentication document to one or more authenticators 130 that may be higher ranked based on providing faster results and/or higher validation results, etc. Alternatively, for a high priority situation, the server 120 may transmit the image of the authentication document may to each of the plurality of authenticators 130.

As another example, when the priority level is set to the high priority level, dynamically setting the validation process may include prompting the user to capture a high resolution image of the identification document. For example, the server 120 may send a notification to the user device 110 that causes the user device 110 to prompt the user to capture a high resolution image of the identification document using, for example, the image capture device 117. After capturing the high resolution image, the user device 110 may then transmit the high resolution image to the server 120, which may then forward the high resolution image to the plurality of authenticators, as discussed above, to validate the high resolution image. Alternatively, the server 120 could prompt the user device 110 for additional identifying information such as social security number, additional documentation (e.g., passport), birth date, real-estate owned, etc. As yet another example, when the priority level is set to the high priority level, dynamically setting the validation process may include performing image adjustments on the identification document to improve a quality of the identification document. In some embodiments, the image adjustments may include adjusting a contrast of the image, a brightness of the image, a color of the image, a resolution of the image, etc. In some embodiments, in response to the identification document being validated, the method 200 may also include providing, using the server 120, the user device 110 with access to the account information at block 225. For example, the server 120 may transmit an account number or credit number issued by the server 120 to user device 110.

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system embodiments other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. A method, comprising:
receiving, at a computing device, a request to access account information of a user from a user device;
in response to receiving the request, analyzing, by the computing device, an environmental context of the user device, wherein analyzing the environmental context comprises analyzing a global positioning system (GPS) location of the user device, a wireless connection of the user device, a beacon signal received by the user device, or a current usage of the user device;
determining, by the computing device, a priority level for validating an identification document of the user based on the environmental context;
dynamically setting, by the computing device, a validation process for validating the identification document based on the priority level, wherein the priority level and the validation process change for each request to access the account information based on the environmental context of the user device at the time of the request; and
in response to the identification document being validated, providing, by the computing device, the user device with access to the account information.

2. The method of claim 1, wherein analyzing the global positioning system (GPS) location of the user device, the wireless connection of the user device, the beacon signal received by the user device, or the current usage of the user device comprises one or more of:
determining whether the user device is near a point-of-sale system based on the GPS location of the user device, the wireless connection of the user device, or the beacon signal received by the user device;
determining whether the user is attempting to conduct an on-line purchase at a public location or a home location based on the GPS location of the user device or the wireless connection of the user device;
determining whether the user is attempting to conduct a purchase while traveling based on travel predictions;
determining whether the user is attempting to conduct a purchase at a location where a previous purchase was conducted using the GPS location of the user device or the wireless connection of the user device;
determining whether the user is attempting to conduct a purchase using a mobile application operating on the user device;
determining whether the user is updating a payment form for one or more mobile applications operating on the user device;
determining whether the user is activating a credit card; or
determining whether the user is attempting to access the account information without attempting to conduct a transaction.

3. The method of claim 2, wherein determining the priority level comprises setting the priority level to a high priority level when the user device is near the point-of-sale system, the user is attempting to conduct the on-line purchase at the public location, the user is attempting to conduct the purchase while traveling, the user is attempting to conduct the purchase at the location where the previous purchase was conducted, the user is attempting to conduct the purchase using the mobile application operating on the user device, the user is updating the payment, or the user is activating the credit card.

4. The method of claim 3, wherein, when the priority level is set to the high priority level, dynamically setting the validation process comprises one or more of:
transmitting the identification document to a plurality of authenticators;
prompting the user to capture a high resolution image of the identification document; or
performing image adjustments on the identification document to improve a quality of the identification document.

5. The method of claim 4, wherein a first authenticator of the plurality of authenticators comprises a primary authenticator that first attempts to validate the identification document and remaining authenticators of the plurality of authenticators comprise secondary authenticators that attempt to validate the identification document when the first authenticator fails to validate the identification document.

6. The method of claim 4, wherein each of the plurality of authenticators simultaneously attempt to validate the identification document.

7. The method of claim 3, wherein determining the priority level comprises setting the priority level to a low priority level when the user is attempting to access the account information without attempting to conduct the transaction or the user is attempting to conduct the on-line purchase at the home location.

8. A system, comprising:
a memory for storing instructions for dynamically setting a validation process for validating an identification document of a user; and
a processor, communicatively coupled to the memory, configured to execute the instructions, the instructions causing the processor to:
receive a request to access account information of the user from a user device;
in response to receiving the request, analyze an environmental context of the user device, wherein analyzing the environmental context comprises analyzing a global positioning system (GPS) location of the user device, a wireless connection of the user device, a beacon signal received by the user device, or a current usage of the user device;
determine a priority level for validating the identification document based on the environmental context;
dynamically set the validation process for validating the identification document based on the priority level, wherein the priority level and the validation process change for each request to access the account information based on the environmental context of the user device at the time of the request; and
in response to the identification document being validated, provide the user device with access to the account information.

9. The system of claim 8, wherein, to analyze the global positioning system (GPS) location of the user device, the wireless connection of the user device, the beacon_signal received by the user device, or the current usage of the user device, the processor is further configured to:
determine whether the user device is near a point-of-sale system based on the GPS_location of the user device, the wireless connection of the user device, or the beacon signal received by the user device;
determining whether the user is attempting to conduct an on-line purchase at a public location or a home location based on the GPS location of the user device or the wireless connection of the user device;
determine whether the user is attempting to conduct a purchase while traveling based on travel predictions;
determining whether the user is attempting to conduct a purchase at a location where a previous purchase was conducted using the GPS location of the user device or the wireless connection of the user device;
determine whether the user is attempting to conduct a purchase using a mobile application operating on the user device;
determine whether the user is updating a payment form for one or more mobile applications operating on the user device;
determine whether the user is activating a credit card; or
determine whether the user is attempting to access the account information without attempting to conduct a transaction.

10. The system of claim 9, wherein the processor is further configured to set the priority level to a high priority level when the user device is near the point-of-sale system, the user is attempting to conduct the on-line purchase at the public location, the user is attempting to conduct the purchase while travelling, the user is attempting to conduct the purchase at the location where the previous purchase was conducted, the user is attempting to conduct the purchase using the mobile application operating on the user device, the user is updating the payment, or the user is activating the credit card.

11. The system of claim 10, wherein, when the priority level is set to the high priority level, dynamically setting the validation process comprises one or more of:
transmitting the identification document to a plurality of authenticators;
prompting the user to capture a high resolution image of the identification document; or
performing image adjustments on the identification document to improve a quality of the identification document.

12. The system of claim 11, wherein a first authenticator of the plurality of authenticators comprises a primary authenticator that first attempts to validate the identification document and remaining authenticators of the plurality of authenticators comprise secondary authenticators that attempt to validate the identification document when the first authenticator fails to validate the identification document.

13. The system of claim 11, wherein each of the plurality of authenticators simultaneously attempt to validate the identification document.

14. The system of claim 9, wherein the processor is further configured to set the priority level to a low priority level when the user is attempting to access the account information without attempting to conduct the transaction or the user is attempting to conduct the on-line purchase at the home location.

15. A non-transitory, tangible computer-readable device having instructions stored thereon that, when executed by at least one computing device, causes the at least one computing device to perform operations comprising:
receiving, at a computing device, a request to access account information of a user from a user device;
in response to receiving the request, analyzing, by the computing device, an environmental context of the user device, wherein analyzing the environmental context comprises analyzing a global positioning system (GPS) location of the user device, a wireless connection of the user device, a beacon signal received by the user device, or a current usage of the user device;
determining, by the computing device, a priority level for validating an identification document of the user based on the environmental context;
dynamically setting, by the computing device, a validation process for validating the identification document based on the priority level, wherein the priority level and the validation process change for each request to access the account information based on the environmental context of the user device at the time of the request; and
in response to the identification document being validated, providing, by the computing device, the user device with access to the account information.

16. The non-transitory, tangible computer-readable device of claim 15, wherein analyzing the global positioning system (GPS) location of the user device, the wireless connection of the user device, the beacon signal received by the user device, or the current usage of the user device comprises one or more of:
determining whether the user device is near a point-of-sale system based on the GPS location of the user device, the wireless connection of the user device, or the beacon signal received by the user device;
determining whether the user is attempting to conduct an on-line purchase at a public location or a home location based on the GPS location of the user device or the wireless connection of the user device;
determining whether the user is attempting to conduct a purchase while travelling based on travel predictions;
determining whether the user is attempting to conduct a purchase at a location where a previous purchase was conducted using the GPS location or the wireless connection;
determining whether the user is attempting to conduct a purchase at a location where a previous purchase was conducted using the GPS location of the user device or the wireless connection of the user device;
determining whether the user is updating a payment form for one or more mobile applications operating on the user device;
determining whether the user is activating a credit card; or
determining whether the user is attempting to access the account information without attempting to conduct a transaction.

17. The non-transitory, tangible computer-readable device of claim 16, wherein determining the priority level comprises setting the priority level to a high priority level when the user device is near the point-of-sale system, the user is attempting to conduct the on-line purchase at the public location, the user is attempting to conduct the purchase while travelling, the user is attempting to conduct the purchase at the location where the previous purchase was conducted, the user is attempting to conduct the purchase using the mobile application operating on the user device, the user is updating the payment, or the user is activating the credit card.

18. The non-transitory, tangible computer-readable device of claim 17, wherein, when the priority level is set to the high priority level, dynamically setting the validation process comprises one or more of:
transmitting the identification document to a plurality of authenticators;
prompting the user to capture a high resolution image of the identification document; or
performing image adjustments on the identification document to improve a quality of the identification document.

19. The non-transitory, tangible computer-readable device of claim 18, wherein a first authenticator of the plurality of authenticators comprises a primary authenticator that first attempts to validate the identification document and remaining authenticators of the plurality of authenticators comprises secondary authenticators that attempt to validate the identification document when the first authenticator fails to validate the identification document.

20. The non-transitory, tangible computer-readable device of claim 16, wherein determining the priority level comprises setting the priority level to a low priority level when the user is attempting to access the account information without attempting to conduct the transaction or the user is attempting to conduct the on-line purchase at the home location.
